(19) United States
(12) Patent Application Publication
(10) Pub. No.: US 2026/0247301 A1
(43) Pub. Date: Aug. 20, 2026

(54) PER ANTENNA POWER CONTROL

(71) Applicant: Google LLC, Mountain View, CA (US)

(72) Inventors: Jibing Wang, San Jose, CA (US); Erik Stauffer, Sunnyvale, CA (US)

(21) Appl. No.: 19/161,995

(22) PCT Filed: Apr. 2, 2024
(86) PCT No.: PCT/US2024/022641

§ 371 Date: Sep. 3, 2025

Related U.S. Application Data
(60) Provisional application No. 63/493,868, filed on Apr. 3, 2023.

(51) Int. Cl. H04W 52/32; H04W 52/14; H04W 52/36

(52) U.S. Cl. CPC H04W 52/32; H04W 52/14; H04W 52/365

(57) ABSTRACT

This disclosure provides systems, methods, and apparatus, including computer programs encoded on computer-readable media, that perform per antenna power control in a user equipment (UE 110). A base station (108) transmits a message indicating desired power levels for each individual antenna port. The base station can transmit desired power levels for individual antenna ports for physical uplink shared channel (PUSCH), physical uplink control channel (PUCCH), and sounding reference signal (SRS) communication. The UE can determine path loss values on an individual antenna port (203) basis. Further, the UE can transmit power headroom reports (PHRs 122) for each individual antenna port. The base station can update transmit power for individual antenna ports by issuing Transmit Power Control (TPC) commands (120) indicating to the UE changes (for example, delta values) in transmission power on a per antenna port basis.

### RELATED APPLICATION

This application claims the priority benefit of U.S. Provisional Patent Application Ser. No. 63/493,868, filed Apr. 3, 2023, and entitled “PER ANTENNA POWER CONTROL,” the entire contents of which is hereby incorporated by reference herein.

### TECHNICAL FIELD

Aspects of the present disclosure relate generally to wireless communication and techniques for uplink per antenna port power control in a wireless communication system.

### DESCRIPTION OF THE RELATED TECHNOLOGY

Generally, a provider of a wireless network manages wireless communications over the wireless network. For example, a base station manages a wireless connection with a user device that is connected to the wireless network. The base station determines configurations for the wireless connection, such as bandwidth, timing, protocol, and power levels for the wireless connection. The base station then transmits control messages to the user device to instruct the user device of the configurations for the wireless connection. For example, a base station transmits power control commands that instruct the user device regarding adjustments to power levels that the user device is to use for transmitting signals to the base station. The user device incorporates the adjustments, along with signal quality information to determine a power level for transmissions to the base station. The user device attempts to balance various factors when it calculates a power level to use for transmission to the base station. These factors include assuring good signal quality, avoiding interference with other user devices, and avoiding overconsumption of battery resources on the user device.

User devices now typically include multiple physical antennas. A user device manages a physical antenna (or a physical antenna array) using an antenna port. Antenna ports are logical constructs that do not necessarily correspond to physical antennas. Instead, antenna ports are distinguished by their reference signal sequences. In some cases, multiple antenna port signals can be transmitted on a single physical antenna. Alternatively, in some cases, a single antenna port signal can be spread across multiple physical antennas. As noted above, during communications between a user device and a base station, the base station sends to the user device instructions regarding power levels and adjustments to power levels that the user device should use when calculating a power level to use for transmitting to the base station. Existing user device implementations typically receive this power level and divide it equally among the user device's multiple antenna ports. That is, the user device typically configures each antenna port to transmit at the same power level.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for transmit power control by a user equipment (UE) having a plurality of antenna ports. The method includes receiving, by the UE from a base station, one or more Transmit Power Control (TPC) commands for one or more antenna ports of the plurality of antenna ports, wherein each TPC command of the one or more TPC commands includes an antenna port identifier identifying an antenna port of the plurality of antenna ports and an indicator of a power level delta for the antenna port. The method includes calculating, by the UE, a Reference Signal Received Power (RSRP) value for each of the plurality of antenna ports. The method includes calculating, by the UE, a path loss value for each of the plurality of antenna ports using the RSRP for the antenna port. And, the method includes transmitting, by the UE, a first signal to the base station using the plurality of antenna ports, wherein a transmit power level for each antenna port of the one or more antenna ports is calculated in accordance with the path loss value for the antenna port and the indicator of the power level delta for the antenna port.

Another innovative aspect of the subject matter described in this disclosure can be implemented in a method for controlling transmit power of a user equipment (UE) by a base station. The method includes receiving, by the base station from the UE, a UE capability message including a first indicator that the UE has a plurality of antenna ports and a second indicator that the UE is capable of performing per antenna port power control. The method includes calculating, by the base station for each antenna port of the plurality of antenna ports of the UE, an indicator of signal quality of a signal received by the base station from the UE via the antenna port. The method includes calculating, by the base station for each antenna port of the plurality of antenna ports of the UE, a power level delta for the antenna port based on the indicator of the signal quality for the antenna port. And, the method includes transmitting, by the base station to the UE, a first signal including Downlink Control Information (DCI), the DCI including, for each antenna port of the plurality of antenna ports, an antenna port identifier identifying the antenna port and an indicator of the power level delta for the antenna port.

Aspects of the subject matter described in this disclosure can be implemented in a UE. The UE includes a communication unit and a processing system. The processing system is configured to control the communication unit to implement any one of the above-referenced methods.

Aspects of the subject matter described in this disclosure can be implemented in a base station. The base station includes a communication unit and a processing system. The processing system is configured to control the communication unit to implement any one of the above-referenced methods.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example wireless system employing per antenna power control.

FIG. 2 is a diagram illustrating example configurations of a base station and a user equipment.

FIG. 3 is a diagram illustrating a communication process between a base station and

a user equipment.

FIG. 4 is a flow chart diagram illustrating a method for transmit power control performed by a user equipment.

FIG. 5 is a flow chart diagram illustrating a method for user equipment transmit power control performed by a base station in accordance with aspects of this disclosure.

### DETAILED DESCRIPTION

The following description is directed to certain implementations for the purpose of describing the innovative aspects of this disclosure. However, a person having ordinary skill in the art will readily recognize that the teachings herein can be applied in a multitude of different ways. Some of the examples in this disclosure are based on wireless communication according to the 3^{rd} Generation Partnership Project (3GPP) wireless standards, such as the 4^{th} generation (4G) long term evolution (LTE) and 5^{th} generation (5G) new radio (NR) standards. However, the described implementations can be implemented in any device, system, or network that is capable of transmitting and receiving radio frequency signals according to any of the wireless communication standards, including any of the Institute of Electrical and Electronics Engineers (IEEE) 802.11, 802.15, or 802.16 wireless standards, or other known signals that are used to communicate within a wireless, cellular, or internet of things (IOT) network, such as a system utilizing 3G, 4G, 5G, WiFi or future radio technology.

Various aspects of this disclosure relate to per antenna power control of multiple antennas of a UE (in other words, a user device). As noted above, during communications between a UE and a base station, the base station sends to the UE instructions regarding power levels and adjustments to power levels that the UE should use when calculating a power level to use for transmitting to the base station. Existing UE implementations typically receive this power level and divide it equally among the UE's multiple antenna ports. A technical problem with such existing power control implementations for antenna ports is that this equal splitting can have undesirable results when different physical antennas experience different power constraints. For example, a physical antenna might be blocked by a hand while other physical antennas are not. Further, a physical antenna can have a different Specific Absorption Rate (SAR) from other physical antennas. Thermal issues within the UE might also affect the ability for a physical antenna to transmit at high power levels.

As a technical solution to the above, and according to aspects of the disclosure, a base station transmits a message indicating desired power levels for each individual antenna port. For example, a base station can transmit desired power levels for individual antenna ports for physical uplink shared channel (PUSCH), physical uplink control channel (PUCCH), and sounding reference signal (SRS) communication. A UE can determine path loss values on an individual antenna port basis. Further, a UE can transmit power headroom reports (PHRs) for each individual antenna port. The base station can update transmit power for individual antenna ports by issuing Transmit Power Control (TPC) commands indicating to the UE changes (for example, delta values) in transmission power on a per antenna port basis.

The aspects of the disclosure may be implemented in various practical applications as systems, methods, and apparatuses that provide per antenna power control for UE antenna ports. These systems, methods and apparatuses can provide advantages over existing systems. For example, UEs that implement the techniques described herein can make more efficient use of battery resources while maintaining a good signal quality. Further, the techniques described herein can avoid interference between UEs communicating with a base station.

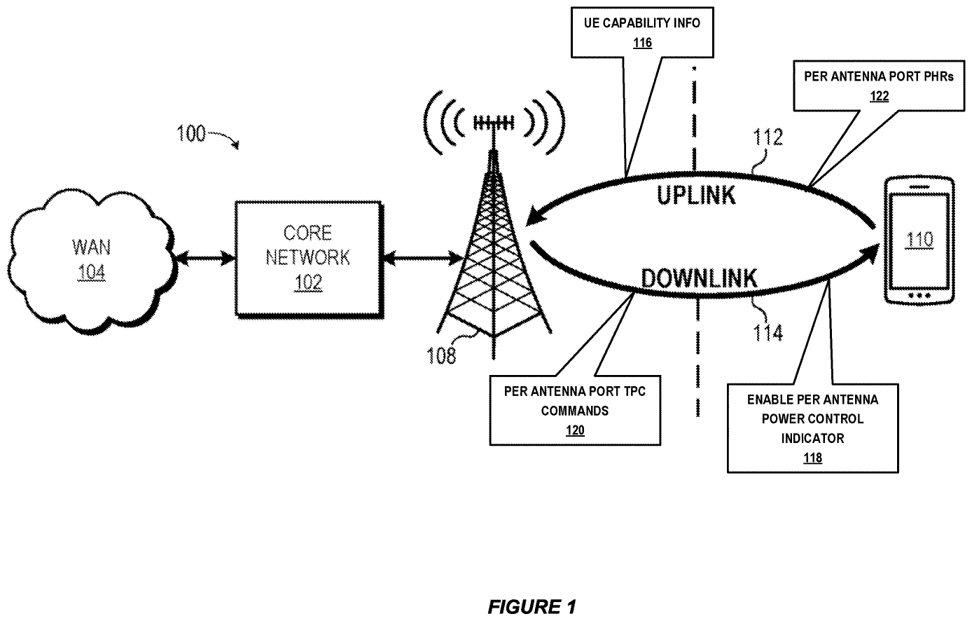

FIG. 1 is a diagram illustrating an example wireless system employing per antenna power control. In the example illustrated in FIG. 1, UE 110 and base station 108 perform downlink (DL) and uplink (UL) operations in wireless communications network 100 that provide per antenna power control. As depicted, the wireless communication network 100 is a cellular network including a core network 102 coupled to one or more wide area networks (WANs) 104 or other packet data networks (PDNs), such as the Internet. Each base station 108 supports wireless communication with one or more UEs, such as UE 110, via radio frequency (RF) signaling using one or more applicable radio access technologies (RATs) as specified by one or more communications protocols or standards. As such, the base station 108 operates as the wireless interface between the UE 110 and various networks and services provided by the core network 102 and other networks, such as packet-switched (PS) data services, circuit-switched (CS) services, and the like. Conventionally, communication of signaling from the base station 108 to the UE 110 is referred to as “downlink” or “DL” whereas communication of signaling from the UE 110 to the base station 108 is referred to as “uplink” or “UL.”

Base station 108 can employ any of a variety of RATs, such as operating as a NodeB (or base transceiver station (BTS)) for a Universal Mobile Telecommunications System (UMTS) RAT (also known as “3G”), operating as an enhanced NodeB (eNodeB) for a 3GPP LTE RAT, operating as a 5G node B (“gNB”) for a 3GPP 5G NR RAT, and the like. UE 110, in turn, can implement any of a variety of electronic devices operable to communicate with the base station 108 via a suitable RAT, including, for example, a mobile cellular phone, a cellular-enabled tablet computer or laptop computer, a desktop computer, a cellular-enabled video game system, a server, a cellular-enabled appliance, a cellular-enabled automotive communications system, a cellular-enabled smartwatch or other wearable device, and the like.

Communication of information over an air interface formed between the base station 108 and the UE 110 takes the form of RF signals that represent both control plane signaling and user data plane signaling. However, due to the relatively high frequencies and relatively tight timing margins typically employed, the RF signaling is susceptible to attenuation and interference. In some cases, this attenuation and interference can be attributed to issues related to one or more antennas of UE 110. For example, a body part (such as a hand or head) may be blocking one or more of the antennas of UE 110. In other cases, thermal issues on UE 110 or SAR issues may affect the ability of an antenna of UE 110 to transmit a signal to base station 108. As noted above, existing systems divide power equally among the antenna ports of a UE. Thus, existing systems have no way to compensate when one or more of the physical antennas are blocked or are experiencing thermal or SAR issues.

As an advantage over existing systems, base station 108 and UE 110 implement per antenna power control. Using techniques described herein, base station 108 and UE 110 cooperate to determine power levels for antenna ports that can optimize communications between base station 108 and UE 110. For example, instead of equally dividing power between the antenna ports of UE 110 as is done in existing systems, UE 110 and base station 108 can utilize the techniques described herein to tailor transmit power for individual antenna ports to compensate for issues that may affect only some of the antennas on UE 110. Thus, communication efficiency between base station 108 and UE 110 can be optimized. Additionally, power usage on UE 110 can be optimized.

Communications between base station 108 and UE 110 utilize a UL transmission path 112 for RF transmissions from the UE 110 to the base station 108 and a DL transmission path 114 for RF transmissions from the base station 108 to the UE 110. As such, in the context of the UL transmission path 112, the UE 110 serves as the data sending device and the base station 108 serves as the data receiving device, whereas in the context of the DL transmission path 114, the base station 108 serves as the data sending device and the UE 110 serves as the data receiving device. UL transmission path 112 and DL transmission path 114 may utilize multiple communications channels for signal transmission. The multiple channels may each have different purposes.

UL transmission path 112 may include a PUSCH, a PUCCH, and a Physical Random Access Channel (PRACH). The PUSCH is used for the transmission of user data, such as voice data, video data, or text message data from UE 110 to base station 108. Additionally, the PUSCH can be used to transmit control information (e.g., Uplink Control Information (UCI)). The PUSCH may be shared by multiple UEs. The PUCCH is used for transmitting control information from the UE to the network, such as channel quality feedback, scheduling requests, and acknowledgments. The PRACH is used for random access in the uplink direction, allowing the UE to send data to the network without a prior reservation.

DL transmission path 114 may include one or more of a Physical Downlink Shared Channel (PDSCH), a Physical Downlink Control Channel (PDCCH), a Physical Broadcast Channel (PBCH), or a paging channel. The PDSCH is used for transmission of user data from the base station to the mobile device. The PDSCH may be shared by multiple UEs. As with the PUSCH, the data can be any type of information, such as voice data, video data, or text message data. The paging channel is used to notify UE 110 that there is incoming traffic for it from base station 108.

The techniques described herein can be implemented as part of a closed loop power control mechanism for the UL transmission path 112. Generally speaking, closed loop power control involves adjusting the transmit power of a UE to maintain a target signal-to-noise ratio (SNR) in a receiver. The target SNR is set such that signal quality is optimal and the radio link is reliable and efficient. In closed loop power control, a base station (for example, base station 108) measures the signal quality of a signal received from a UE (for example, UE 110). The base station sends power control commands to the UE that instruct the UE to adjust the transmit power in order to cause the measured SNR to move towards the target SNR. Thus, a feedback loop exists in which the base station calculates a power level needed to maintain a target SNR, and the UE adjusts its transmit power based on feedback from the base station. In existing systems, the closed loop power control is based on a single signal quality value that is calculated across all of the antenna ports of the UE. Similarly, a single power adjustment calculated by the base station and transmitted to the UE in a power control command is divided equally across all of the antennal ports. According to techniques of the disclosure, signal quality is measured for each antenna port and per antenna power control commands are provided to adjust the transmission power of each individual antenna port.

In operation, UE 110 connects to base station 108. As part of the connection process, UE 110 provides UE capability information 116 to base station 108 via UL transmission path 112. UE capability information 116 can include information indicating the antenna ports on UE 110, and an indicator that informs the base station whether or not UE 110 supports per antenna port power control. Base station 108 receives the UE capability information. If the UE capability information indicates that UE 110 supports per antenna port power control, base station 108 can transmit and enable per antenna power control indicator 118 to UE 110 via DL transmission path 114. Enabling per antenna power control indicator 118 instructs the UE to utilize per antenna power control procedures when calculating transmit power levels or reporting power headroom.

In accordance with techniques described herein, when per antenna port power control is enabled, base station 108 transmits per antenna port TPC commands 120 via DL transmission path 114 that, when received by UE 110, are used by UE 110 to calculate on a per antenna port basis the transmit power used for each antenna port. In other words, UE 110 calculates a transmit power individually for each antenna port. For example, base station 108 can calculate power level deltas for each antenna port individually based on the signal quality of a signal transmitted by the antenna port via UL transmission path 112. UE 110 receives the power level deltas for individual antenna ports, and uses the power level delta for an antenna port to calculate the transmit power to be used for the corresponding antenna port.

Similarly, in accordance with techniques described herein, UE 110 can calculate power headroom for each individual antenna port. Generally speaking, power headroom is the amount of power available to UE 110 for increasing transmission power. In conventional systems, the power headroom is the amount of power available to UE 110 for increasing power across all antenna ports. In accordance with techniques described herein, UE 110 calculates power headroom for each individual antenna port. UE 110 can transmit PHRs for individual antenna ports via UL transmission path 112. The PHR can include an indicator of the power headroom for the antenna port and an index or other identifier of the antenna port.

Upon receiving a PHR having individual antenna port power headroom indicators, base station 108 can use the PHR for an antenna port along with the signal quality of a signal transmitted via the antenna port to calculate a power level delta for the antenna port. The power level delta can indicate a requested increase in transmit power level if the signal quality is not sufficient and there is headroom for a power level increase for the antenna port. The power level delta can indicate a requested decrease in transmit power level for the antenna port if the signal quality is good, thereby facilitating a reduction in power consumption by UE 110.

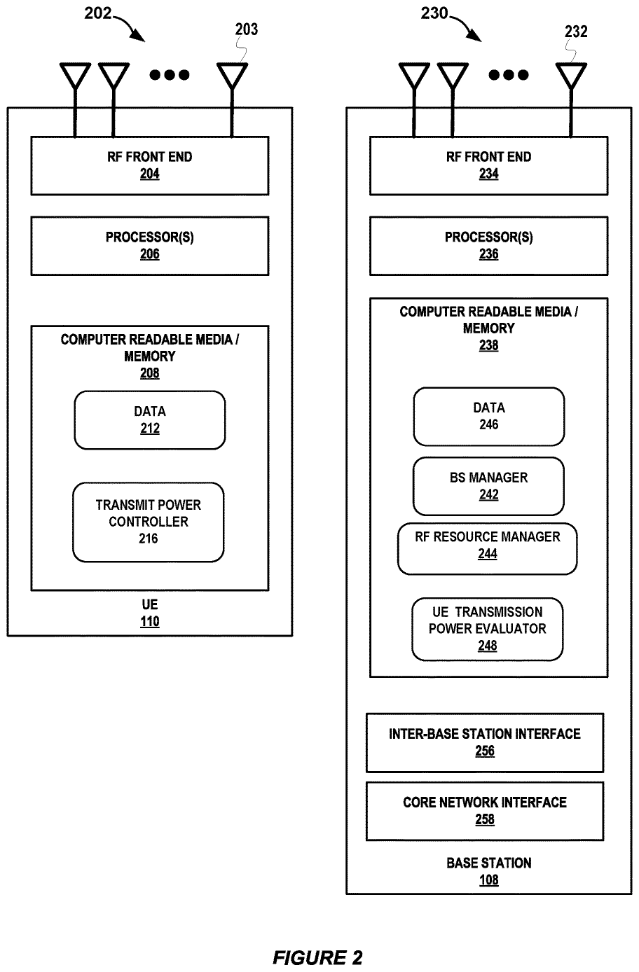

FIG. 2 is a diagram illustrating example configurations of a base station 108 and a UE 110. Note that the depicted hardware configurations represent the processing components and communication components related UE per antenna power control described herein and omit certain components well-understood to be frequently implemented in such electronic devices, such as displays, peripherals, power supplies, and the like.

In the example configuration shown in FIG. 2, UE 110 includes one or more antenna arrays 202, with each antenna array 202 having one or more antennas 203. The one or more antennas 203 may be structured with a dual polarization configuration. In some aspects, each antenna 203 may have a horizontal polarization and/or vertical polarization. UE 110 further includes an RF front end 204, one or more processors 206, and one or more non-transitory computer-readable media 208. The RF front end 204 includes one or more modems configured for the corresponding RAT(s) employed (for example, 3GPP 5G NR), one or more analog-to-digital converters (ADCs), one or more digital-to-analog converters (DACs), signal processors, and the like.

The RF front end 204 operates, in effect, as a physical (PHY) transceiver interface to conduct and process signaling between the one or more processors 206 and the antenna array 202 so as to facilitate various types of wireless communication. The antennas 203 can include an array of multiple antennas that are configured similar to or different from each other and can be tuned to one or more frequency bands associated with a corresponding RAT. The one or more processors 206 can include, for example, one or more central processing units (CPUs), graphics processing units (GPUs), or other application-specific integrated circuits (ASIC), and the like. To illustrate, the processors 206 can include an application processor (AP) utilized by the UE 110 to execute an operating system and various user-level software applications, as well as one or more processors utilized by modems or a baseband processor of the RF front end 204. The computer-readable media 208 can include any of a variety of media used by electronic devices to store data and/or executable instructions, such as random access memory (RAM), read-only memory (ROM), caches, Flash memory, solid-state drive (SSD) or other mass-storage devices, and the like. For ease of illustration and brevity, the computer-readable media 208 is referred to herein as “memory 208” in view of frequent use of system memory or other memory to store data and instructions for execution by the processor 206, but it will be understood that reference to “memory 208” shall apply equally to other types of storage media unless otherwise noted.

The one or more memories 208 of UE 110 are used to store one or more sets of executable software instructions and associated data that manipulate the one or more processors 206 and other components of the UE 110 to perform the various functions described herein and attributed to the UE 110. The sets of executable software instructions include, for example, an operating system (OS) and various drivers (not shown), and various software applications (not shown). and transmit power controller 216. The data stored in the one or more memories 208 includes, for example, data 212. The data 212 represents, for example, user data, multimedia data, beamforming codebooks, software application configuration information, current transmit power levels, and the like.

Transmit power controller 216 manages transmission power for antenna ports 203. In some aspects, the transmit power controller 216 of UE 110 configures transmission power levels for communication with one or more other devices, such as base station 108. Further, the transmit power controller 216 may configure different transmission power levels for one or more various types of communications. For example, the transmit power controller 216 may configure a relatively lower transmission power level for control messages and a relatively higher transmission power level for application data, such as video streaming. In other examples, the transmit power controller 216 may configure different transmission power levels for one or more wireless channels. In some of these implementations, the transmit power controller 216 may configure a relatively low transmission power level for transmissions over a PUCCH and a relatively high transmission power level for transmission over a PUSCH.

Additionally, transmit power controller 216 can utilize the techniques described herein to configure different transmission power levels for different antenna ports based on feedback from base station 108. Thus, transmit power controller 216 can configure different transmission power levels for antenna ports transmitting signals over the same channel, for example, a PUSCH. For example, when per antenna power control is enabled, transmit power controller 216 can calculate transmit power for individual antenna ports based on per antenna power deltas calculated by base station 108 and transmitted to UE 110. Further, transmit power controller 216 can calculate power headroom values for individual antenna ports. UE 110 can transmit individual power headroom values to base station 108 as indicators in a PHR.

In some implementations, transmit power controller 216 configures initial transmission power levels, receives, from base station 108 via DL transmission path 114 (FIG. 1), a TPC command to change the transmission power for an antenna port to different transmission power level, and then reconfigures the transmission power levels for the antenna port indicated in the TPC command to the updated transmission power level. The TPC command may indicate a relative change to a transmission power level, such as a request to increase the transmission power level for the antenna port by a predetermined amount (e.g., −6 dB, −4 dB, −2 dB, 2 dB, 4 dB, 6 dB, 8 dB, etc.).

Turning to the hardware configuration of the base station 108, it is noted that although FIG. 2 illustrates an implementation of the base station 108 as a single network node (for example, a 5G NR Node B, or “gNB”), the functionality, and thus the hardware components, of the base station 108 instead may be distributed across multiple network nodes or devices and may be distributed in a manner to perform the functions described herein. As one example, the functionality of base station 108 may be distributed across a radio unit (RU), distributed unit (DU), or central unit (CU). Similar to UE 110, base station 108 includes at least one array 230 of one or more antennas 232, an RF front end 234, as well as one or more processors 236 and one or more non-transitory computer-readable storage media 238 (as with the memory 208 of the UE 110, the computer-readable medium 238 is referred to herein as a “memory 238” for brevity). Similar to RF front end 204, the RF front end 234 includes one or more modems, one or more ADCs, one or more DACs, and the like. RF front end 234 receives the one or more RF signals, for example, RF signals from UE 110, and pre-processes the one or more RF signals to generate data from the RF signals that is provided as input to processes and/or applications executing on base station 108. This pre-processing can include, for example, power amplification, conversion of band-pass signaling to baseband signaling, initial analog-to-digital conversion, and the like.

The one or more memories 238 of the base station 108 store one or more sets of executable software instructions and associated data that manipulate the one or more processors 236 and other components of the base station 108 to perform the various functions described herein and attributed to the base station 108. The sets of executable software instructions include, for example, an operating system (OS) and various drivers (not shown), various software applications (not shown), a base station (BS) manager 242, and a RF resource manager 244. The BS manager 242 configures the RF front end 234 for communication with the UE 110, as well as communication with a core network, such as the core network 102 (FIG. 1).

In some aspects, the RF resource manager 244 of the base station 108 is implemented to perform various functions associated with allocating physical access (for example, resource blocks) or communication resources for the air interface of the base station 108. The air interface of the base station 108, may be partitioned or divided into various units (for example, frames, subframes, or slots) of one or more of bandwidth, time, symbols, or spatial layers. For example, within a framework of a 5G NR protocol, the RF resource manager 244 can allocate bandwidth and time intervals of access in resource blocks, each of which may be allocated in whole, or in part, to one or more channels for communicating with the UE 110. The channels may include one or more of a PRACH, a PUCCH, a PUSCH, a PDCCH, a PDSCH, a PBCH, or a paging channel.

The resource blocks may include multiple subcarriers that each span a portion of a frequency domain of the resource blocks. The subcarriers may be further divided into resource elements, or orthogonal frequency-division multiplexing (OFDM) symbols, that each span a portion of a time domain of the subcarriers. Consequently, a resource block includes multiple OFDM symbols that can be grouped into subcarriers with other OFDM symbols having a common frequency bandwidth.

In some embodiments, RF resource manager 244 includes a UE transmission power evaluator 248. UE transmission power evaluator 248 determines power level deltas for antenna ports of a UE (for example, antenna ports 203).

The data stored in the one or more memories 238 of the base station 108 includes, for example, data 246. The data 246 represents, for example, network scheduling data, radio resource management data, beamforming codebooks, software application configuration information, UE transmitter power levels, and the like.

In some embodiments, the base station 108 further includes an inter-base station interface 256, such as an Xn or X2 interface, which the BS manager 242 configures to exchange user-plane, control-plane, and other information between other BSs, and to manage the communication of the base station 108 with the UE 110. The base station 108 further can include a core network interface 258 that the BS manager 242 configures to exchange user-plane, control-plane, and other information with core network functions and/or entities of core network 102 (FIG. 1).

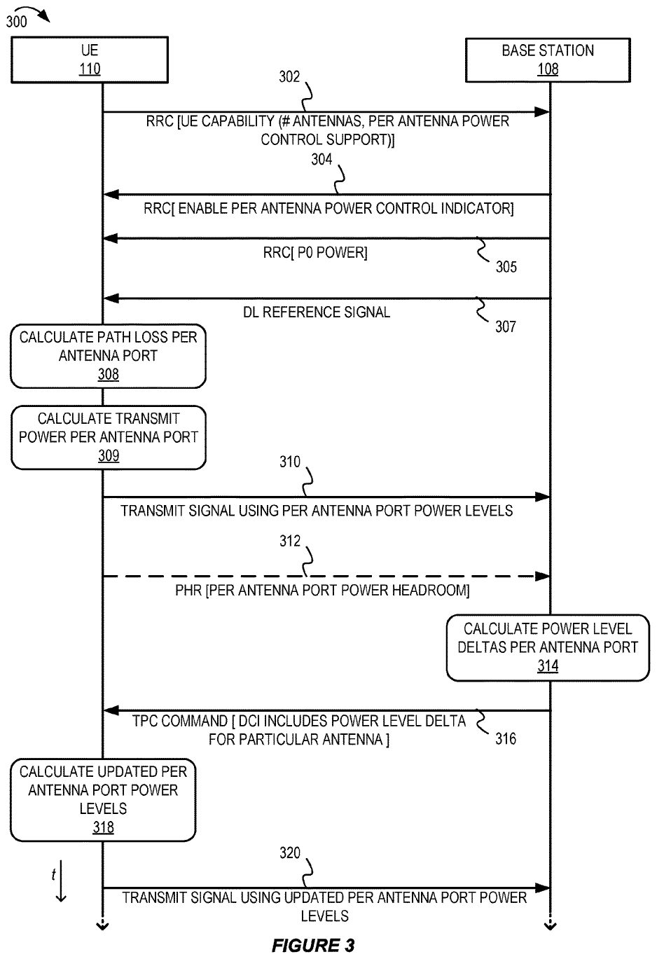

FIG. 3 is a diagram illustrating a communication process 300 between a base station 108 and a user equipment 110. In some aspects, communication process 300 begins at operation 302 where UE 110 transmits UE capability information to base station 108. UE capability information can include supported frequency bands, radio access technologies, maximum transmission power, maximum data rates, and network protocols. In some aspects, UE capability information may include information about antenna ports on a UE and an indicator informing base station 108 whether or not UE 110 supports per antenna power control. For example, UE 110 can communicate physical layer capability parameters of the UE 110 to the base station 108 during an initial communication session setup process between the UE 110 and base station 108. In some implementations that conform to 5G network communication standards, these physical layer capability parameters can include a supportedCSI-RS-ResourceList parameter that can specify resources that UE 110 supports. The supportedCSI-RS-ResourceList can include a totalnumbertxportsperband field that indicates the number of transmit ports available across all carrier components within a supported band on the UE 110. In some aspects, an additional field of the supportedCSI-RS-ResourceList can indicate whether or not the UE 110 supports per antenna power control. However, other parameters of the UE capability information can specify whether or not UE 110 supports per antenna power control.

At operation 304, base station 108, in response to determining that UE 110 supports per antenna power control, transmits a radio resource control (RRC) message including a field indicating that the UE should enable per antenna power control. For example, the RRC message may include a configuration enabling per antenna power control for an uplink channel. After receiving the RRC message, UE 110 begins to calculate transmit power on a per antenna port basis and ceases to divide power equally among the antenna ports.

At operation 305, base station 108 transmits to UE 110 an RRC message indicating a nominal power level for an uplink channel. For example, the RRC message may indicate a nominal PUSCH power P0 power to the UE. PUSCH nominal value can be signaled per UE transmission (TX) antenna separately or the same nominal value can be signaled in the system information block (SIB) (e.g., SIB2) or the dedicated RRC message to the UE. It is possible that a SIB only signals a single nominal value while a dedicated RRC message can signal different nominal value for each TX antenna at the UE side depending on the UE capability. P0 is a parameter that specifies the power level of the uplink channel. In other words, P0 refers to the amount of power that UE 110 should transmit when communicating with base station 108 on the uplink channel. Typically, it is a fixed value that is set by the network operator or system designer to ensure that the signal transmitted by the device is received with an appropriate level of power at the base station. As detailed below, a UE 110 can make adjustments to the transmit power for an antenna port from the Nominal PUSCH power P0 power.

At operation 307, base station 108 transmits to UE 110 a reference signal via DL transmission path 114 (FIG. 1). In some aspects, the reference signal can be a Channel State Information Reference Signal (CSI-RS). CSI-RS is used to estimate the channel state information (CSI) between the base station 108 and the UE 110, and is useful in facilitating accurate transmission and reception of data. The CSI-RS is used to measure various parameters such as the channel quality, signal strength, and interference levels, which can be used to optimize the transmission of data over the wireless network. The CSI-RS can be configured with various parameters such as frequency, time, and antenna configurations, to enable accurate estimation of the channel state information under different conditions. The CSI-RS can be configured as a semi-persistent signal, a periodic signal, or an aperiodic signal.

In some aspects, the reference signal can be determined using Synchronization Signal Blocks (SSBs), which may include primary and secondary synchronization signals (PSS and SSS) and PBCH.

At operation 308, UE 110 calculates path loss on a per antenna port basis. In other words, UE 110 makes a separate path loss calculation for each antenna port. UE 110 receives the reference signal (e.g., CSI-RS, SSB) from the base station 108 and can calculate a Reference Signal Received Power (RSRP) for each antenna port. UE 110 can then use the RSRP and other information to calculate the path loss for each antenna port. In some aspects, the path loss is calculated per polarization. For example, antennas having a horizontal and vertical polarization, UE 110 calculates a path loss for the horizontal polarization and a path loss for the vertical polarization.

At operation 309, UE 110 can calculate transmit power separately for each antenna port using the RSRP for each respective antenna port and the path loss for each respective antenna port.

At operation 310, UE 110 uses the calculated transmit powers for the antenna ports to transmit a signal to base station 108. For example, the UE 110 can use the calculated transmit powers to transmit the signal via the PUCCH, PUSCH or SRS depending on the type of signal being transmitted (e.g., control, user data, or reference signal).

Optionally, at operation 312, UE 110 can transmit one or more PHRs to base station 108 for one or more antenna ports. In some aspects, the power headroom may provide a difference between a nominal UE maximum transmit power and the estimated power for PUSCH or PUCCH transmission for the antenna port. In other aspects, the power headroom may provide a difference between a nominal UE maximum transmit power and an estimated SRS transmission for the antenna port. The PHR for an antenna port can include an indicator of power headroom for the antenna port and an index or other identifier of the antenna port for which the PHR is being reported. In some aspects, base station 108 can specify when the UE is to transmit a PHR for an antenna port. For example, base station 108 may specify periodic or aperiodic reporting.

In some aspects, UE 110 can utilize delta signaling of PHR indicators. For example, UE 110 can send a PHR for a first antenna port (for example, an antenna port having an index of 1). PHRs for subsequent antenna ports can be specified as a delta with respect to the PHR of the first antenna port. For example, the UE 110 can send a PHR where the first PHR for a first antenna port is an absolute value, and subsequent PHRs for subsequent antenna ports are specified as a difference between the PHR for the first antenna port and the PHR of the subsequent antenna port.

At operation 314, base station 108 receives and processes the signal transmitted by UE 110 via the one or more antenna ports. Additionally, base station 108 calculates power level deltas (in other words, power level changes) for each antenna port of UE 110 that was used in the transmission of the signal. The power level deltas can be calculated based on the signal quality of each antenna port of UE 110. In some aspects, the signal quality can be a Channel Quality Indicator (CQI). The CQI is a metric calculated by UE 110 and transmitted to base station 108. In some aspects, CQI is calculated for each antenna port based on the SNR or signal-to-interference-plus-noise ratio (SINR) of the signal received via the antenna port. UE 110 calculates the SNR or SINR based on the received signal and, for each antenna port, reports it back to base station 108 using a CQI index. The CQI index represents a specific range of SNR or SINR values for the antenna port and is used by base station 108 to calculate a desired transmit power level for the UE 110. The power level delta can then be calculated as the difference between the current transmit power level and the desired transmit power level.

At operation 316, base station 108 transmits a TPC to UE 110 that includes the power level deltas for each antenna port. In some aspects, the power level deltas for the antenna ports may be included in downlink control information (DCI) that, for each antenna port, has an indicator of the power level delta and an index or other identifier of the antenna port. There are multiple formats for DCI, and the format for the DCI depends on channel conditions, modulation and coding scheme (MCS), beamforming, bandwidth, and resource allocation among other considerations. In some aspects, a TPC command will include a two bit TPC command field and an n-bit TPC antenna port identifier where n is large enough to uniquely identify the maximum number of antenna ports on UE 110. The TPC antenna port identifier can be an index or other value identifying the antenna port to which the TPC command applies. Table 1 provides example TPC command field values and the power level delta mapped to the command field for a PUSCH in some DCI formats. In the example shown in Table 1, the first column is the TPC command, the second column provides power level delta values mapped to the command when the UE is configured to use accumulated power when processing TPC commands. In this case, the UE adds the value mapped by the TPC command to the current transmit power. In the absolute case, the UE sets the transmit power to the absolute value mapped to the TPC command.

TABLE 1

| TPC Command Field | Accumulated [dB] | Absolute [dB] |
|---|---|---|
| 0 | −1 | −4 |
| 1 | 0 | −1 |
| 2 | 1 | 1 |
| 3 | 3 | 4 |

Table 2 provides example TPC command field values and the power level delta mapped to the command field for a PUCCH in some DCI formats. In some aspects, TPC commands for the PUCCH are mapped to accumulation values. Thus, in the example shown in Table 2, the first column is the TPC command and the second column provides the power level delta values mapped to the TPC command. The power level delta mapped to a TPC command is added to the current transmit power for the PUCCH.

TABLE 2

| TPC Command Field | Accumulated [dB] |
|---|---|
| 0 | −1 |
| 1 | 0 |
| 2 | 1 |
| 3 | 3 |

At operation 318, UE 110 calculates updated transmit power values for each antenna port. In some aspects, UE 110 calculates the updated transmit power each antenna port based, at least in part, on the current transmit power and the power level delta for the antenna port received from base station 108 via the TPC command at operation 316.

At operation 320, UE 110 transmits a signal to base station 108 using the updated per antenna power levels calculated at operation 318. For example, the UE 110 can use the calculated transmit powers to transmit the signal via the PUCCH, PUSCH or SRS depending on the type of signal being transmitted (e.g., control, user data, or reference signal).

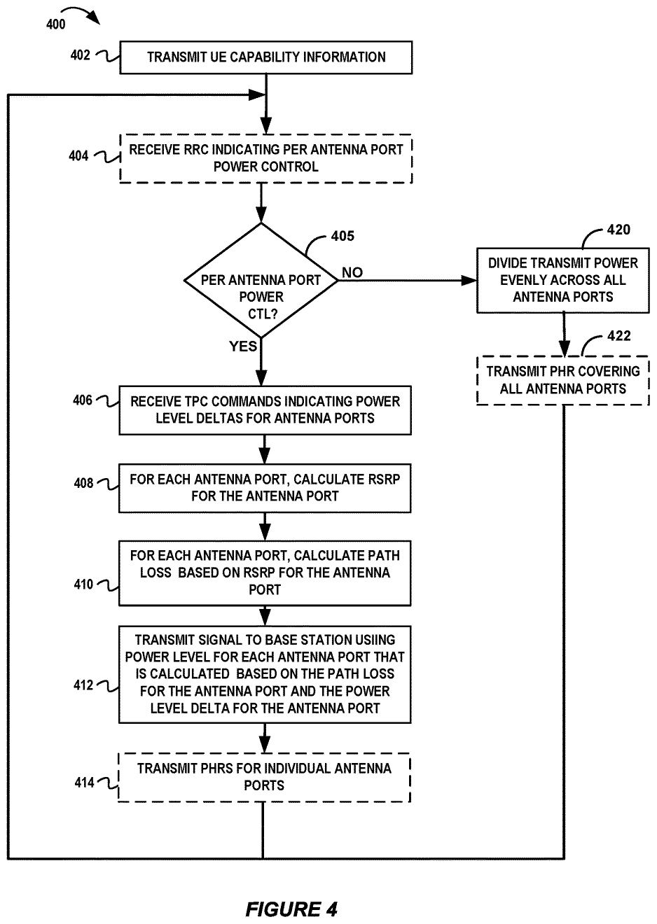

FIG. 4 is a flow chart diagram 400 illustrating operations of a method for transmit power control performed by a UE. The operations of the method may be performed, for example, by UE 110 of FIGS. 1, 2 and 3.

The method begins at block 402, where the UE transmits UE capability information. As discussed above with respect to operation 302 of FIG. 3, the UE capability information can include supported frequency bands, radio access technologies, maximum transmission power, maximum data rates, and network protocols. In some aspects, the UE capability information may include information about antenna ports on a UE and an indicator informing base station 108 whether or not UE 110 supports per antenna power control.

At block 404, the UE can receive, from a base station, an RRC message indicating whether or not the UE is to utilize per antenna power control. For example, as discussed above with respect to operation 304 of FIG. 3, if the base station supports per antenna control and the UE has indicated that it supports per antenna power control in the UE capability information, then the base station may send an RRC message that configures the UE to utilize per antenna power control for uplink transmissions. If the base station does not support per antenna power control, no such RRC message will be received from the base station.

At decision block 405, the UE determines if per antenna power control has been enabled. For example, if the UE does not receive, from the base station, that per antenna power control is to be utilized by the UE (“NO” branch of decision block 405), then at block 420, the UE can divide power equally across the antenna ports. Additionally, at block 422, the UE may optionally transmit PHRs that indicate power headroom for all of the antennas as a group.

In some aspects, the UE may receive a DCI message that includes an indicator indicating to the UE to utilize per antenna power control. If the UE has received, from the base station, such an indicator enabling per antenna power control (“YES” branch of decision block 405), the UE proceeds to utilize per antenna power control.

At block 406 and as discussed above with respect to operation 316 of FIG. 3, the UE receives one or more TPC commands from the base station. The TPC commands can include the power level deltas for each antenna port. In some aspects, the power level deltas for the antenna ports may be included in a DCI that, for each antenna port, has an indicator of the power level delta and an index or other identifier of the antenna port. In some aspects, the power level deltas and antenna port indices/identifiers may be included in a medium access control (MAC) control element (CE) message.

At block 408, the UE calculates an RSRP for each antenna port. The reference signal is typically transmitted using a specific antenna port. The RSRP measurement is based on the signal power received from that antenna port. In some aspects, RSRP is calculated by measuring the power of the reference signal (RS) received by the UE and then normalizing the measured power based on the bandwidth of the channel.

At block 410, the UE calculates path loss on a per antenna port basis. In other words, the UE makes a separate path loss calculation for each antenna port. The UE can use the RSRP and other information to calculate the path loss for each antenna port.

At block 412 and as discussed above with respect to operation 318 of FIG. 3, the UE calculates a transmit power separately for each antenna port using the RSRP for each respective antenna port and uses the updated transmit power for each antenna port to transmit a signal via the antenna ports to the base station. In some aspects, the DCI message may include scheduling information (e.g., time-frequency resources, etc.) for an uplink transmission. Accordingly, the UE transmits the uplink transmission to the base station using the updated per antenna power levels.

Optionally, at block 414, the UE can transmit one or more PHRs to the base station for one or more antenna ports. The PHR for an antenna port can include an indicator of power headroom for the antenna port and an index or other identifier of the antenna port for which the PHR is being reported.

Some or all of the operations at blocks 404-422 may be repeated for the duration of a communications session between the UE and the base station. For example, the UE receives one or more subsequent TPC commands from the base station. The subsequent TPC commands can include the power level deltas for one or more antenna ports. In response to receiving the subsequent TPCs, the UE calculates updated transmit power values for the one or more antenna ports specified by the TPC. In some aspects, the UE calculates the updated transmit power for the one or more antenna ports based, at least in part, on the current transmit power and the power level delta for the antenna port received from base station via the TPC commands. The UE then transmits a subsequent signal to the base station using the updated per antenna power levels.

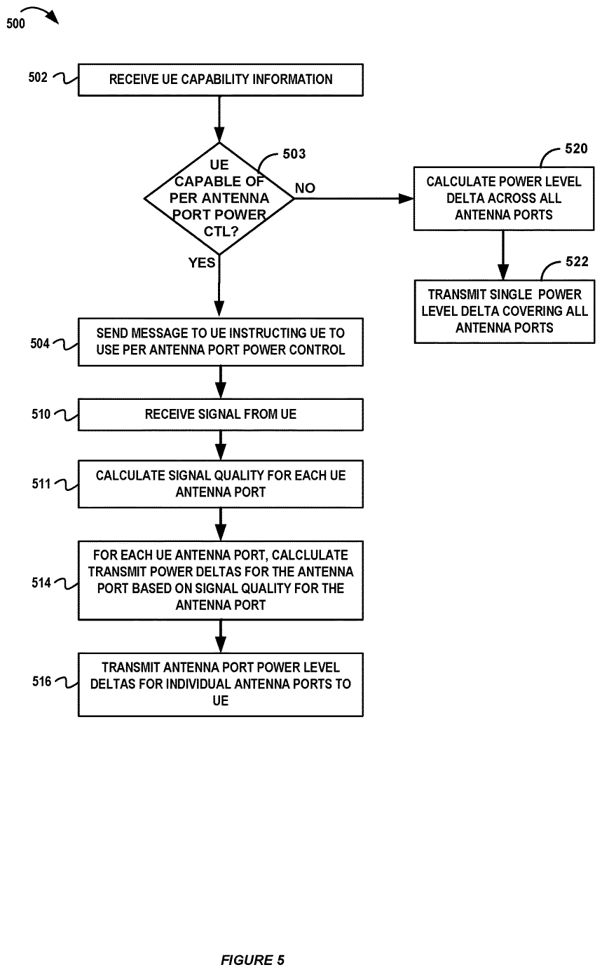

FIG. 5 is a flow chart diagram 500 illustrating operations of a method for user equipment transmit power control performed by a base station in accordance with aspects of this disclosure. The operations of the method may be performed, for example, by base station 108 of FIGS. 1, 2 and 3. The method begins at block 502 where the base station receives UE capability information from a UE. As an example and as discussed above with respect to operation 302 of FIG. 3, the UE capability information may be received as part of a connection process establishing a communication session between the base station and the UE. As discussed above, the UE capability information can include supported frequency bands, radio access technologies, maximum transmission power, maximum data rates, and network protocols. In some aspects, UE capability information may include information about antenna ports on the UE and an indicator informing the base station whether or not UE 110 supports per antenna power control.

At decision block 503, the base station determines if the UE supports per antenna power control. If the UE does not support per antenna power control (“NO” branch of decision block 503), then at block 520 the base station calculates a power level delta that applies across all of the antenna ports of the UE as a group. That is, the base station calculates a power level that is divided equally among all of the antenna ports of the UE. At block 522, the base station transmits the power level delta to the UE.

If the UE does support per antenna power control (“YES” branch of decision block 503), then at block 504, as discussed above with respect to operation 304 of FIG. 3, the base station sends a message to the UE to instruct the UE to utilize per antenna power control.

At block 510 and as discussed above with respect to operation 310 of FIG. 3, the base station receives and processes the signal transmitted by the UE via the UE's one or more antenna ports.

At block 511, the base determines a signal quality of the signal received by the base station from the UE. In some aspects, the signal quality can be a Channel Quality Indicator (CQI) received from the UE. As described above, the CQI is a metric calculated by a UE and transmitted to the base station. In some aspects, CQI is calculated for each antenna port based on the SNR or SINR of the signal received via the antenna port. In some aspects, the base station receives a CQI index as part of the signal received from the UE. The CQI index represents a specific range of SNR or SINR values for the antenna port.

In some aspects, the base station determines the signal quality based on measuring the signal transmitted by the UE. For example, the base station can calculate the signal quality by measuring the signal quality of an SRS transmitted by the UE.

At block 514 and as discussed above with respect to operation 314 of FIG. 3, the base station calculates power level deltas (in other words, power level changes) for each antenna port of the UE that was used in the transmission of the signal. The power level deltas can be calculated based on the signal quality of the signal received via each antenna port of the UE. The power level delta can then be calculated as the difference between the current transmit power level and the desired transmit power level.

At block 516 and as discussed above with respect to operation 316 of FIG. 3, the base station transmits one or more TPC commands to UE 110 that include the power level deltas for each antenna port. In some aspects, the power level deltas for the antenna ports may be included in a DCI that, for each antenna port, has an indicator of the power level delta and an index or other identifier of the antenna port. The base station DCI can specify the switching from total closed-loop power control (e.g., total transmit power is split equally across all antenna ports) to the per transmit antenna closed-loop power control. For example, for single layer transmission, total power closed-loop control can be used, while for the multiple-input and multiple-output (MIMO) transmission (e.g., multiple transmission layers), per transmit antenna closed-loop power control is used. The DCI can include a field indicating whether the uplink power control command is applicable to all the transmit antenna ports or it is for a specific transmit antenna port from the UE side. In case of multiple transmit antenna ports, there can be a power control command sent with respect to the individual TX antenna port. For example, the DCI field can include the transmit antenna port index for the corresponding transmit power control command.

The operations of blocks 510-516 can be repeated during the communication session between the base station and the UE.

The discussion above has been presented in the context of a closed loop power control mechanism for a UL transmission path (for example, UL transmission path 112 of FIG. 1). However, the techniques can be readily adapted for closed loop power control for a DL transmission path (for example, DL transmission path 114 of FIG. 1). For example, base station 108 can transmit a reference signal (e.g., CSI-RS or SSB) from a plurality of antenna ports of the base station. The UE 110 can receive the reference signal from the base station 108, and use the reference signal to generate uplink control information (UCI). The UE 110 can send a UCI message including channel feedback (e.g., CSI report) on a per antenna port basis. In some aspects, the UCI can include power control commands for downlink transmission on a per layer basis (e.g., transmission layers in downlink MIMO). The base station 108 can use a power control command to perform per antenna power control on downlink transmissions (e.g., PDCCH, PDSCH, etc.).

Additionally, it will be appreciated that while the techniques disclosed here have been discussed in the context of per antenna power control for a UE, the same techniques can be readily adapted to facilitate per antenna power control in a base station. For example, a UE can send power control commands for a base station to instruction. In some aspects, the UE can send power control commands on a per layer basis. For example, the UE can instruct the base station as to what power levels to use when transmitting data for individual MIMO layers via a DL transmission path.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes.

As used herein, the terms “component” and “module” are intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

In this disclosure, the term “can” indicates a capability, or alternatively indicates a possible implementation option. The term “may” indicates a permission, or alternatively indicates a possible implementation option. The term “might” indicates a possible utilization of an implementation option.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with processing circuitry, examples of which include a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

As used herein, the terms “user equipment”, “wireless communication device”, “mobile communication device”, “communication device”, or “mobile device” refer to any one or all of cellular telephones, smartphones, portable computing devices, personal or mobile multi-media players, laptop computers, tablet computers, smartbooks, Internet-of-Things (IOT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers or routers, and similar electronic devices which include a processing circuitry such as a programmable processor, memory, and other circuitry configured to perform operations as described herein.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method for transmit power control by a user equipment (UE) having a plurality of antenna ports, comprising:
receiving, from a network node, one or more transmit power control (TPC) commands for one or more antenna ports of the plurality of antenna ports, wherein each TPC command of the one or more TPC commands includes an antenna port identifier identifying an antenna port of the plurality of antenna ports and an indicator of a power level delta for the antenna port;
calculating, by the UE, a reference signal received power (RSRP) value for each antenna port of the plurality of antenna ports;
calculating, by the UE, a path loss value for each antenna port of the plurality of antenna ports using the RSRP value for the respective antenna port; and
transmitting, to the network node, a first signal using the plurality of antenna ports, wherein a transmit power level for each antenna port of the plurality of antenna ports is calculated in accordance with the path loss value for the respective antenna port and the indicator of the power level delta for the respective antenna port.

2. The method of claim 1, wherein each antenna port is mapped to one or more physical antennas.

3. The method of claim 1, wherein the antenna port has a first polarization and a second polarization different from the first polarization, and wherein the calculating the path loss value includes calculating a first path loss value for the first polarization and a second path loss value for the second polarization.

4. The method of claim 1, further comprising:
transmitting, to the network node, a power headroom report (PHR) for one or more of the antenna ports, the PHR including, for each antenna port of the one or more antenna ports, an indicator of a power headroom for the antenna port and the antenna port identifier of the antenna port.

5. The method of claim 4, wherein the antenna port comprises a first antenna port, and wherein the power headroom for the first antenna port comprises a difference between the power headroom of the first antenna port and the power headroom of a second antenna port of the one or more antenna ports.

6. The method of claim 1, further comprising:
receiving, from the network node, a system information block (SIB) including an indicator of a power level;
in response to the receiving the SIB, performing splitting of the power level equally across the plurality of antenna ports for uplink transmissions;
receiving, from the network node, downlink control information (DCI) including an indicator to use per antenna power control; and
in response to the receiving the DCI, stopping the splitting of the power level equally across the plurality of antenna ports and starting calculating the power level separately for each antenna port of the plurality of antenna ports.

7. The method of claim 1, wherein the transmitting the first signal comprises transmitting the first signal via at least one of: a physical uplink shared channel (PUSCH), a physical uplink control channel (PUCCH), or a sounding reference signal (SRS).

8. The method of claim 1, wherein the antenna port identifier comprises an indicator in the one or more TPC commands.

9. The method of claim 8, wherein the indicator of the antenna port identifier and the indicator of the power level delta are combined into a single indicator.

10. A method for controlling transmit power of a user equipment (UE) by a network node, comprising:
receiving, from the UE, a UE capability message including a first indicator that the UE has a plurality of antenna ports and a second indicator that the UE is capable of performing per antenna port power control;
calculating, by the network node for each antenna port of the plurality of antenna ports of the UE, a signal quality of a signal received by the network node from the UE via the antenna port;
calculating, by the network node for each antenna port of the plurality of antenna ports of the UE, a power level delta for the antenna port based on the signal quality for the antenna port; and
transmitting, to the UE, a first signal including downlink control information (DCI), the DCI including, for each antenna port of the plurality of antenna ports, an antenna port identifier identifying the antenna port and an indicator of the power level delta for the antenna port.

11. The method of claim 10, further comprising:
transmitting a radio resource control (RRC) message to configure the UE with per antenna power control.

12. The method of claim 10, further comprising:
receiving, from the UE, a power headroom report (PHR) for one or more of the plurality of antenna ports of the UE, the PHR including a power headroom for an antenna port of the plurality of antenna ports;
wherein the calculating, by the network node for each antenna port of the plurality of antenna ports of the UE, the power level delta for the antenna port comprises calculating the power level delta based on the signal quality and the power headroom for the antenna port.

13. The method of claim 12, wherein the indicator of the power headroom for a first antenna port of the plurality of antenna ports comprises a difference between a first power headroom of the first antenna port and a second power headroom of a second antenna port of the plurality of antenna ports.

14. The method of claim 10, further comprising:
transmitting, to the UE, a second signal including a DCI indicator that indicates the UE is to utilize per antenna port power control.

15. The method of claim 10, wherein the antenna port identifier identifying the antenna port and the indicator of the power level delta for the antenna port are included as indicators in a transmit power control (TPC) command encoded in the first signal.

16. An apparatus for wireless communication, comprising:
a communication unit; and
a processing system configured to control the communication unit to:
receive, from a network node, one or more transmit power control (TPC) commands for one or more antenna ports of a plurality of antenna ports, wherein each TPC command of the one or more TPC commands includes an antenna port identifier identifying an antenna port of the plurality of antenna ports and an indicator of a power level delta for the antenna port;
calculate a reference signal received power (RSRP) value for each antenna port of the plurality of antenna ports;
calculate a path loss value for each antenna port of the plurality of antenna ports using the RSRP value for the respective antenna port; and
transmit, to the network node, a first signal using the plurality of antenna ports, wherein a transmit power level for each antenna port of the plurality of antenna ports is calculated in accordance with the path loss value for the respective antenna port and the indicator of the power level delta for the respective antenna port.

17. The apparatus for wireless communication of claim 16, wherein the processing system is further configured to control the communication unit to:
transmit, to the network node, a power headroom report (PHR) for one or more of the antenna ports, the PHR including, for each antenna port of the one or more antenna ports, an indicator of a power headroom for the antenna port and the antenna port identifier of the antenna port,
wherein the antenna port comprises a first antenna port, and wherein the power headroom for the first antenna port comprises a difference between the power headroom of the first antenna port and the power headroom of a second antenna port of the one or more antenna ports.

18. The apparatus for wireless communication of claim 16, wherein the processing system is further configured to control the communication unit to:
receive, from the network node, a system information block (SIB) including an indicator of a power level;
perform splitting of the power level equally across the plurality of antenna ports for uplink transmissions based on the receipt of the SIB;
receive, from the network node, downlink control information (DCI) including an indicator to use per antenna power control; and
based on the receiving the DCI, stop the splitting of the power level equally across the plurality of antenna ports and start calculating the power level separately for each antenna port of the plurality of antenna ports.

19. The apparatus for wireless communication of claim 16, wherein the processing system is configured to control the communication unit to transmit the first signal via at least one of:
a physical uplink shared channel (PUSCH),
a physical uplink control channel (PUCCH), or
a sounding reference signal (SRS).

20. The apparatus for wireless communication of claim 16, wherein the antenna port identifier comprises an indicator in the one or more TPC commands.
